(19) United States
(12) Patent Application Publication
(10) Pub. No.: US 2024/0400431 A1
(43) Pub. Date: Dec. 5, 2024

(54) METHOD FOR PRODUCING GASEOUS DIHYDROGEN AND AMMONIUM SULFATE FROM AN AQUEOUS LIQUID EFFLUENT, SUCH AS THE LIQUID FRACTION OF A PIG MANURE OR HUMAN URINE

(71) Applicant: SANOF'AGRI, Crédin (FR)

(72) Inventor: Louesdon Stéphane, Crédin (FR)

(21) Appl. No.: 18/696,022

(22) PCT Filed: Sep. 26, 2022
(86) PCT No.: PCT/EP2022/076729

§ 371 Date: Mar. 27, 2024

(30) Foreign Application Priority Data
Sep. 27, 2021 (FR) 2110121

(51) Int. Cl. C02F 9/00; B01D 61/02; B01D 61/04; B01D 69/02; B01D 71/02; B01D 71/56; C01C 1/24; C02F 1/02; C02F 1/44; C02F 1/461; C02F 101/10; C02F 101/16; C02F 103/00; C02F 103/20; C25B 1/04; C25B 1/29; C25B 1/55; C25B 15/021

(52) U.S. Cl. CPC C02F 9/00; B01D 61/026; B01D 61/027; B01D 61/029; B01D 61/04; B01D 69/02; B01D 71/02; B01D 71/56; C01C 1/24; C25B 1/04; C25B 1/29; C25B 1/55; C25B 15/021; B01D 2311/06; B01D 2325/02832; C02F 1/02; C02F 1/441; C02F 1/442; C02F 1/461; C02F 2101/105; C02F 2101/16; C02F 2103/005; C02F 2103/20; C02F 2201/46165; C02F 2301/08

(57) ABSTRACT

The invention concerns a process for producing gaseous dihydrogen and ammonium sulphate from an aqueous liquid effluent containing organic and inorganic materials or a mixture of aqueous liquid effluents,

said process comprising the following steps:
nanofiltration of said aqueous liquid effluent or said mixture of aqueous liquid effluents so as to obtain a permeate;
ammonia stripping of the permeate from said nanofiltration step in an ammonia stripping unit so as to obtain an ammonium sulphate;
treatment by reverse osmosis of at least part of the permeate extracted from the ammonia stripping unit after said ammonia stripping step, so as to obtain an osmosed aqueous solution;
electrolysis of at least part of said osmosis aqueous solution so as to decompose said part of said osmosis aqueous solution into at least gaseous dihydrogen.

### 1. SCOPE OF THE INVENTION

The field of the invention is the recovery of agricultural effluents. More specifically, the invention relates to a process for producing hydrogen gas and ammonium sulphate from an aqueous liquid effluent containing organic and inorganic materials or from a mixture of aqueous liquid effluents containing organic and inorganic materials.

The invention can be used in particular to recover pig slurry, the liquid fraction of digestate from a methaniser, the liquid fraction of digestate from sewage plant sludge, waste water and human urine.

### 2. STATE OF THE ART

In 2019, France and Europe have expressed their desire to develop a “green” hydrogen industry based on the electrolysis of water.

Currently, around 4% of the world's gaseous hydrogen is produced by water electrolysis. These known production techniques are mainly based on the use of fresh water.

Fresh water is a precious and limited resource, so it has recently been proposed to produce gaseous dihydrogen from seawater.

One disadvantage of seawater is that the chloride ions it contains can corrode the anode of the electrolyser and prevent or limit oxidation-reduction reactions. In the agricultural sector, hydrogen production techniques are known that consist of methanising plant waste and livestock effluents, such as manure or slurry, to produce biogas, which, after being purified, is mixed with steam at high temperature and high pressure in the presence of a catalyst to obtain hydrogen by steam reforming.

One disadvantage of this known technique is that for every 1 kg of hydrogen produced, 9 kg of CO2 are released into the atmosphere. It is therefore not an environmentally friendly technique.

Other techniques are known for recovering slurry. Slurry can be spread on agricultural land. However, the areas available for spreading are limited. Spreading also causes nitrogen pollution in watercourses, and spreading liquid manure results in significant ammonia emissions into the atmosphere. To overcome these disadvantages, it has been proposed, for example, to treat the liquid fraction of slurry using “stripping” methods to extract the ammoniacal nitrogen from this liquid fraction and form a mineral fertiliser, ammonium sulphate.

Techniques are also known for dewatering slurry to obtain a dry, nitrogen-rich organic meal that is easier to use than the liquid fraction of the slurry.

One disadvantage of stripping and dehydration techniques is that they consume a lot of energy.

### 3. OBJECTIVES OF THE INVENTION

One of the aims of the invention is therefore to overcome the above-mentioned disadvantages of the state of the art.

More specifically, the aim of the invention is to provide a reliable technique for producing gaseous dihydrogen and ammonium sulphate from an aqueous liquid effluent, such as a liquid fraction of a pig slurry, a liquid fraction of a methaniser digestate, a liquid fraction of a digestate of sewage plant sludge, waste water, human urine or a mixture of one or more of these effluents.

In particular, a particular objective of the invention is to provide a technique that makes it possible to recover the gaseous ammonia contained in the liquid fraction of liquid manure, in the liquid fraction of digestate from a methaniser, in the liquid fraction of digestate from sewage plant sludge, in waste water or in human urine in the form of ammonium sulphate.

Another aim of the invention is to provide such a technique with low energy consumption.

Another aim of the invention is to provide such a technique which is simple to implement and has a low cost.

### 4. EXPLANATION OF THE INVENTION

These objectives, and others that will appear subsequently, are achieved by means of a process for producing gaseous dihydrogen from an aqueous liquid effluent containing organic and inorganic materials or from a mixture of aqueous liquid effluents containing organic and inorganic materials, said aqueous liquid effluent or effluents being selected from the following effluents:
liquid fraction of a liquid slurry, such as pig slurry;
liquid fraction of an anaerobic digestate;
liquid fraction of sewage plant sludge digestate;
waste water;
animal or human urine.

The invention therefore concerns the production of hydrogen gas and ammonium sulphate from aqueous liquid effluents of agricultural, livestock or urban origin. It should be noted that the invention is not limited to the production of hydrogen gas and ammonium sulphate from one of the five aforementioned aqueous liquid effluents, but also concerns the production of hydrogen gas from a mixture of two, three, four or all of the aforementioned aqueous liquid effluents.

It should be noted that in particular embodiments of the invention in which gaseous dihydrogen and ammonium sulphate are produced essentially or partially from pig urine and/or human urine, this urine may be limed or additivated with sodium hydroxide, without departing from the scope of the invention.

It should also be noted that wastewater can be domestic or industrial wastewater, which may or may not have undergone treatment in a wastewater treatment plant.

According to the invention, said process comprises the following steps:
nanofiltration of said aqueous liquid effluent or said mixture of aqueous liquid effluents so as to obtain a permeate;
ammonia stripping of the permeate from said nanofiltration step in an ammonia stripping unit so as to obtain ammonium sulphate;
treatment by reverse osmosis of at least part of the permeate extracted from the ammonia stripping unit after said ammonia stripping step, so as to obtain an osmosed aqueous solution;
electrolysis of at least part of said osmosis aqueous solution so as to decompose said part of said osmosis aqueous solution into at least gaseous dihydrogen.

The permeate from the nanofiltration stage is advantageously used successively to produce ammonium sulphate, then to obtain osmosis water, after treatment by reverse osmosis, in order to produce gaseous dihydrogen.

In a particularly advantageous embodiment of the invention, such a process comprises a step of heating to at least 50° C., and preferably between 5° and 65° C., said permeate from the nanofiltration step by means of the heat emitted during said electrolysis step, preceding said ammonia stripping step.

The heat recovered from the electrolyser is thus advantageously used to increase the volatility of the ammonia contained in the permeate and consequently the quantity of gaseous ammonia that can be exploited in the stripping stage.

In an advantageous embodiment of the invention, said electrolysis stage is carried out in an electrolyser supplied with electrical energy by photovoltaic collection means and/or by one or more wind turbines.

Advantageously, the pore size of the nanofiltration membrane(s) used during said nanofiltration step is between 4 and 9 nm and preferably between 4 and 6 nm.

In a particular embodiment of the invention, said membrane(s) are ceramic membranes.

According to a particular aspect of the invention, during said nanofiltration step, the pressure differential between upstream and downstream of said nanofiltration membrane(s) is between 3 and 4 bars.

In a particular embodiment of the invention, during said nanofiltration step, said aqueous liquid effluent or said mixture of aqueous liquid effluents is filtered through two and only two nanofiltration membranes.

Preferably, the pressure of said permeate before being treated by reverse osmosis is between 3 and 19 bars.

According to a particular embodiment of the invention, the pressure of said permeate before being treated by reverse osmosis is between 12 and 16 bars. In a particular embodiment of the invention, a process as described above comprises a step of heating said aqueous liquid effluent or said mixture of aqueous liquid effluents prior to said nanofiltration step.

This reduces the viscosity of the aqueous liquid effluent or mixture of aqueous liquid effluents entering the nanofiltration membranes.

### 5. LIST OF FIGURES

Other features and advantages of the invention will become clearer on reading the following description of one embodiment of the invention, given merely as an illustrative and non-limiting example, and of the single appended FIGURE:

FIG. 1 represents a first example of a system for producing gaseous dihydrogen and ammonium sulphate adapted to implement a method for producing gaseous dihydrogen according to the invention.

### 6. DETAILED DESCRIPTION OF THE INVENTION

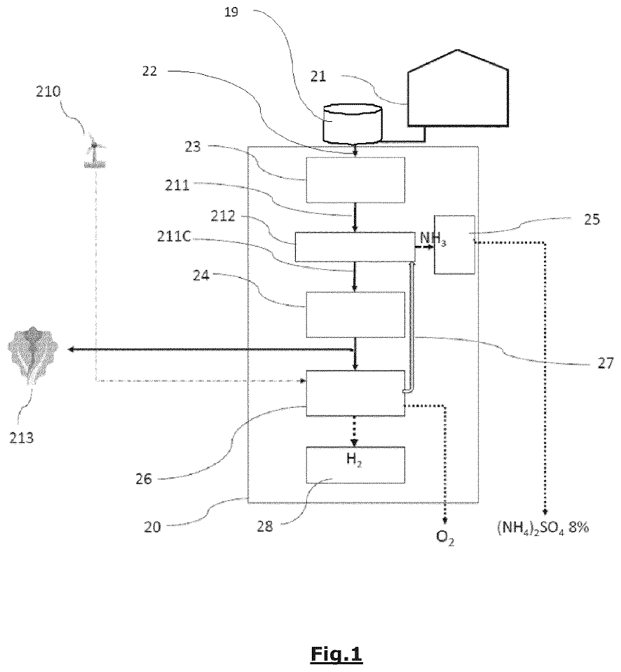

FIG. 1 shows an example of a system for producing gaseous dihydrogen and ammonium sulphate, in which a method for producing gaseous dihydrogen and ammonium sulphate according to the invention is implemented.

This system 20 is fed with pig urine from several farms equipped with phase separation. This urine is contained in a storage tank 19 located outside a building 21, equipped with a pump connected to the system 20 via pipe 22. To separate the liquid fraction from the solid fraction of the slurry, building 21 is equipped with the TRACK process, which allows the liquid part of the slurry to flow into tank 19 and thus separate the liquid fraction from the solid fraction of the slurry.

The pipe 22 leads to a nanofiltration system 23 comprising a membrane surface formed of rotating ceramic discs (made of titanium dioxide) with a pore size of 5 nm, through which the liquid fraction of the slurry is filtered. In this particular embodiment of the invention, the intra-membrane pressure is 3 bars. This intra-membrane pressure is regulated by acting on a retentate extraction control valve.

It should be noted that the membrane surface is washed at regular intervals to prevent it from sticking. In particular, a wash with an alkaline solution, composed for example of potassium hydroxide, chelating agents and dispersants, and a citric acid solution is carried out every 5 days, in this particular embodiment of the invention, to regenerate the filtration capacities of the membrane surface. The retentates are spread.

There was a significant reduction in phosphate content, of around 93%, through the nanofiltration system, and a reduction of around 5% in nitrogen and potassium content.

The permeate leaving the nanofiltration system 23 at a pressure of 13.6 bar is injected into an ammonia stripping treatment unit 212 allowing the production of ammonium sulphate stored in tank 25. The solutes retained in the nanofiltration unit 23 are sent, after being heated to 50° C. using the heat rejected by the electrolyser 26, to the reactor of an ammonia stripping plant 212 in which the gaseous ammonia passes through a sulphuric acid scrubber to form ammonium sulphate.

The permeate obtained after the stripping step 212 is injected into a reverse osmosis unit 24 equipped with polyamide membranes, enabling osmosed water to be collected at its outlet. In this particular embodiment of the invention, the reverse osmosis treatment unit 24 consists of two successive stages of reverse osmosis on a polyamide membrane.

As can be seen from the table [Table 1] below, the osmosis water obtained, or in other words the permeate from the second stage of reverse osmosis, has a greatly reduced nitrogen, phosphate and potassium content compared with the liquid fraction of the slurry, in the order of 97-98%, 97-98% and 92-23% respectively.

| | | | | | | | Permeate | |
|---|---|---|---|---|---|---|---|---|
| | | | | | Retentate | Permeate | derived | |
| | | | Retentate | Permeate | derived | derived | from | |
| | | Slurry | derived | derived | from first | from first | second | |
| | | liquid | from | from | stage | stage | stage | |
| | | initial | nano- | nano- | reverse | reverse | reverse | Reduction |
| Parameter | Unit | fraction | filtration | filtration | osmosis | osmosis | osmosis | (%) |
| Kjeldahl | Mg/l N | 2600 | 2750 | 2360 | 2310 | 950 | 240 | 90.8 |
| nitrogen | | | | | | | | |
| pH | / | 8.3 | 8.3 | 8.5 | 8.5 | 8.7 | 8.7 | / |
| COD | mg/l O2 | 12652 | 14332 | 9700 | 9712 | 3660 | 511 | 96 |
| P205 | mg/l | 120 | 144 | 8 | 14 | 3 | 3 | 97.6 |
| N—NH4 | mg/l N | 2330 | 2410 | 2200 | 2140 | 900 | 216 | 90.1 |
| DM | mg/l | 13011 | 13582 | 11015 | 11129 | 3790 | 1430 | 89 |
| SS | mg/l | 3937 | 3217 | 189 | 19 | 13 | 100 | 97.5 |
| K2O | mg/l | 2801 | 2834 | 2752 | 2715 | 958 | 202 | 92.8 |

In this and the following tables COD refers to Chemical Oxygen Demand, DM to Dry Matter content, SS to Suspended Matter content, P₂O₅ to phosphate content expressed in mg of phosphoric anhydride per litre, N—NH4 to total nitrogen content, K₂O to potassium content expressed in mg of potassium oxide per litre. This osmosis water is pumped to an electrolyser 26, which is supplied with electricity by a set of wind turbines 210.

In electrolyser 26, the osmosis water is broken down into gaseous hydrogen and oxygen. The gaseous hydrogen emitted is compressed and stored in a storage tank 28, while the oxygen emitted is released into the atmosphere. The surplus osmosis water is transferred to a market garden plot 213 for vegetable production.

System 20 can also be used to produce gaseous dihydrogen from wastewater or the liquid fraction of limed pig slurry, for example.

An evolution of the properties at the different stages of treatment using system 20 of a volume initially composed of raw wastewater or a liquid fraction of a raw limed pig slurry is presented in the following tables [Table 2] and [Table 3] respectively, by way of example:

| | | | | | | | Permeate | |
|---|---|---|---|---|---|---|---|---|
| | | | | | Retentate | Permeate | derived | |
| | | | Retentate | Permeate | derived | derived | from | |
| | | Slurry | derived | derived | from first | from first | second | |
| | | liquid | from | from | stage | stage | stage | |
| | | initial | nano- | nano- | reverse | reverse | reverse | Reduction |
| Parameter | Unit | fraction | filtration | filtration | osmosis | osmosis | osmosis | (%) |
| Kjeldahl | Mg/l N | 100 | 110 | 59 | 89 | 23 | 13 | 87 |
| nitrogen | | | | | | | | |
| pH | / | 8 | 8.1 | 8 | 8.1 | 8.1 | 7.8 | / |
| COD | mg/l O2 | 1240 | 1502 | 303 | 574 | 404 | 49 | 96.1 |
| P205 | mg/l | 105 | 108 | 80 | 113 | 29 | 4 | 96.3 |
| N—NH4 | mg/l N | 52 | 52 | 46 | 70 | 19 | 19 | 80.8 |
| DM | mg/l | 6160 | 6550 | 5443 | 5943 | 2111 | 1044 | 83.1 |
| SS | mg/l | 616 | 686 | 52 | 52 | 19 | 21 | 96.6 |
| K2O | mg/l | 1627 | 1651 | 1568 | 2457 | 568 | 168 | 89.7 |

| | | | | | | | Permeate | |
|---|---|---|---|---|---|---|---|---|
| | | | | | Retentate | Permeate | derived | |
| | | | Retentate | Permeate | derived | derived | from | |
| | | Slurry | derived | derived | from first | from first | second | |
| | | liquid | from | from | stage | stage | stage | |
| | | initial | nano- | nano- | reverse | reverse | reverse | Reduction |
| Parameter | Unit | fraction | filtration | filtration | osmosis | osmosis | osmosis | (%) |
| Kjeldahl | Mg/l N | 990 | 1010 | 1000 | 850 | 950 | 484 | 51.1 |
| nitrogen | | | | | | | | |
| pH | / | 12.8 | 12.8 | 12.8 | 12.8 | 12.8 | 11.9 | / |
| COD | mg/l O2 | 10924 | 10626 | 9970 | 12158 | 5030 | 833 | 92.4 |
| P205 | mg/l | <2 | <2 | <2 | <2 | <2 | <2 | / |
| N—NH4 | mg/l N | 940 | 890 | 850 | 850 | 890 | 408 | 56.6 |
| DM | mg/l | 15655 | 15419 | 15101 | 18071 | 8470 | 2424 | 84.5 |
| SS | mg/l | 251 | 341 | 81 | 109 | 85 | 100 | 60.2 |
| K2O | mg/l | 2642 | 2312 | 2660 | 2852 | 1510 | 353 | 86.6 |

1. A process for the production of gaseous dihydrogen and ammonium sulphate from an aqueous liquid effluent containing organic and inorganic materials or from a mixture of aqueous liquid effluents containing organic and inorganic materials, said aqueous liquid effluent or effluents being selected from the following effluents:
liquid fraction of a liquid slurry, such as pig slurry;
liquid fraction of an anaerobic digestate;
liquid fraction of sewage plant sludge digestate;
wastewater;
animal or human urine,
said process comprising the following steps:
nanofiltration of said aqueous liquid effluent or said mixture of aqueous liquid effluents so as to obtain a permeate;
ammonia stripping of the permeate from said nanofiltration step in an ammonia stripping unit, so as to obtain ammonium sulphate;
treatment by reverse osmosis of at least part of the permeate extracted from the ammonia stripping unit after said ammonia stripping step, so as to obtain an osmosed aqueous solution;
electrolysis of at least part of said osmosis aqueous solution so as to decompose said part of said osmosis aqueous solution into at least gaseous dihydrogen.

2. The process according to claim 1, characterised in that it comprises a step of heating to at least 50° C., and preferably between 5° and 65° C., said permeate from the nanofiltration step by means of the heat emitted during said electrolysis step, preceding said ammonia stripping step.

3. The process according to claim 1, characterised in that said electrolysis step is carried out in an electrolyser supplied with electrical energy by photovoltaic collection means and/or by one or more wind turbines.

4. The process according to claim 1, characterised in that the size of the pores of the nanofiltration membrane(s) used during said nanofiltration step is between 4 and 9 nm and preferably between 4 and 6 nm.

5. The process according to claim 4, characterised in that said membrane or membranes are ceramic membranes.

6. The process according to claim 4, characterised in that during said nanofiltration step, the pressure differential between upstream and down-stream of said nanofiltration membrane(s) is between 3 and 4 bars.

7. The process according to claim 4, characterised in that during said nanofiltration step said aqueous liquid effluent or said mixture of aqueous liquid effluents is filtered through two and only two nanofiltration membranes.

8. The process according to claim 1, characterised in that the pressure of said permeate before being treated by reverse osmosis is between 3 and 19 bars.

9. The process according to claim 1, characterised in that it comprises a step of heating said aqueous liquid effluent or said mixture of aqueous liquid effluents prior to said nanofiltration step.
